(19) United States
(12) Patent Application Publication
(10) Pub. No.: US 2013/0241777 A1
(43) Pub. Date: Sep. 19, 2013

(54) MULTI-BAND ANTENNA STRUCTURE

(71) Applicants: CHING-WEI CHANG, NEW TAIPEI CITY (TW); YEN-CHAO LI, TAOYUAN COUNTY (TW); JIAN-MIN TSAI, NEW TAIPEI CITY (TW)

(72) Inventors: CHING-WEI CHANG, NEW TAIPEI CITY (TW); YEN-CHAO LI, TAOYUAN COUNTY (TW); JIAN-MIN TSAI, NEW TAIPEI CITY (TW)

(73) Assignee: AUDEN TECHNO CORP., TAOYUAN COUNTY (TW)

(21) Appl. No.: 13/418,396

(22) Filed: Mar. 13, 2012

(51) Int. Cl. H01Q 9/04

(52) U.S. Cl. 343/700 MS

(57) ABSTRACT

The instant disclosure relates to a multi-band antenna structure for accepting a feed signal. The antenna structure includes a grounding portion, a radiating portion, and a tuning portion. The radiating portion is spaced apart from the grounding portion and disposed on one side thereof. The radiating portion has a first and a second radiating segments interconnected perpendicularly. The tuning portion is connected between the first radiating segment and the grounding portion. The tuning portion has a hairpin segment and a grounding segment. The hairpin segment is substantially U-shaped and one end thereof is connected to one end of the first radiating segment proximate to the grounding portion. The opposite ends of the grounding segment are connected to the other end of the hairpin segment and the grounding portion. The connecting location between the first radiating segment and the hairpin segment is used for accepting the feed signal.

### BACKGROUND OF THE INVENTION

1. Field of the Invention

The instant disclosure relates to an antenna structure; more particularly, to a multi-band antenna structure having a hairpin tuning portion for increased antenna efficiency.

2. Descriptions of Related Art

Majority of the wireless communication devices, such as mobile phones, laptops, and tablets, in the market today are equipped with antenna structures. These antenna structures serve as a medium for sending and receiving electromagnetic signals. The antennas are often disposed within the limited space inside the wireless communication devices as a built-in component.

A conventional antenna structure is shown in FIG. 6. Structurally, the antenna structure comprises a grounding portion 1a, a linear radiating portion 2a, and a connecting portion 3a normally connected to the ground portion 1a and the radiating portion 2a on opposite ends. The radiating portion 2a is defined by a high frequency segment 21a and a low frequency segment 22a. The connecting portion 3a is connected between the high and low frequency segments 21a and 22a. The interconnecting location between the connecting portion 3a and the radiating portion 2a is defined as a feeding point O for a feed signal.

Furthermore, the connecting portion 3a has a feeding segment 31a, a connecting segment 32a, and a grounding segment 33a connected in sequence. One end of the feeding segment 31a is perpendicularly connected between the high and low frequency segments 21a and 22a. The opposite ends of the connecting segment 32a are perpendicularly connected to the other end of the feeding segment 31a and one end of the grounding segment 33a. Whereas the other end of the grounding segment 33a is perpendicularly connected to the grounding portion 1a. The perpendicular arrangements between various segments of the connecting portion 3a are used for adjusting the antenna efficiency.

The test results of the high frequency performance for the conventional antenna structure are shown in FIG. 4 by the broken line A. For the low frequency test, the results are shown in FIG. 5 by the broken line A′. Since the efficiency value is an important parameter in the design of antenna structures, the measured data suggest the conventional antenna still has rooms for improvement.

To address the above issues, the inventors strive via industrial experience and academic research to present the instant disclosure, which can effectively improve the limitations described above.

### SUMMARY OF THE INVENTION

The instant disclosure provides a multi-band antenna structure, which utilizes a tuning portion to increase the antenna efficiency in both high and low frequency operations.

Embodiments of the instant disclosure provides a multi-band antenna structure that comprises a grounding portion; a radiating portion spaced apart from the grounding portion and arranged on one side thereof; and a tuning portion arranged between and connecting the grounding and the radiating portions. The radiating portion comprises a first radiating segment and a second radiating segment. One portion of the first radiating segment is arranged pointing toward the grounding portion. The second radiating segment, being a structural extension of the first radiating segment, extends perpendicularly from the first radiating segment. The tuning portion bridges the first radiating segment of the radiating portion and the grounding portion. The tuning portion has a hairpin segment and a grounding segment. The hairpin segment is substantially U-shaped. One end of the hairpin segment is connected to the portion of the first radiating segment that points toward the grounding portion, while the other end thereof bendingly extends to form the grounding segment, which in turn connects the grounding portion. The interconnecting portion between the first radiating segment and the hairpin segment defines a feed point.

Preferably, the hairpin segment has a first arm, a connecting arm, and a second arm sequentially connected in the above mentioned order. The first arm is connected by one end of first radiating segment proximate to the grounding portion. The second arm is arranged between the first arm and the grounding portion, where the second arm is connected to the grounding segment.

Preferably, the first and second arms are substantially parallel to each other.

Preferably, the first radiating segment and the first arm cooperatively form a substantially U-shaped structure.

Preferably, the second radiating segment is connected by one end of the first radiating segment proximate to the grounding portion. The second radiating segment and the first arm are connected to the same location on the first radiating segment but directed toward opposite directions.

Preferably, the second arm is dimensionally shorter than the first arm.

Preferably, in a direction away from the grounding portion, the second radiating segment is connected by one end of the first radiating segment, where the second radiating segment is arranged between the first radiating segment and the first arm.

Preferably, the first and second radiating segments cooperatively define an L-shaped structure.

Preferably, the second radiating segment extends from the first radiating segment toward the first arm and bends to extend in parallel with the first arm.

Preferably, the multi-band antenna structure further has a coupling portion for coupling to the radiating portion by extending from the grounding portion toward the first radiating segment.

Based on the above, the multi-band antenna structure utilizes the signal feed point, the hairpin segment of the tuning portion, and the positions of the first and second radiating segments relative to each other to increase the antenna efficiency for high and low frequency operations.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTIONS OF THE DRAWINGS

FIG. 1 shows a schematic view of a multi-band antenna structure for a first embodiment of the instant disclosure.

FIG. 2 shows a schematic view of a multi-band antenna structure for a second embodiment of the instant disclosure.

FIG. 3 shows a schematic view for a variant of the multi-band antenna structure for the second embodiment of the instant disclosure.

FIG. 4 shows a plot comparing the efficiencies between the multi-band antenna structure of the instant disclosure and a conventional antenna structure for high frequency operation.

FIG. 5 shows a plot comparing the efficiencies between the multi-band antenna structure of the instant disclosure and the conventional antenna structure for low frequency operation.

FIG. 6 shows a schematic view of the conventional antenna structure.

### DETAILED DESCRIPTIONS OF EMBODIMENTS

### First Embodiment

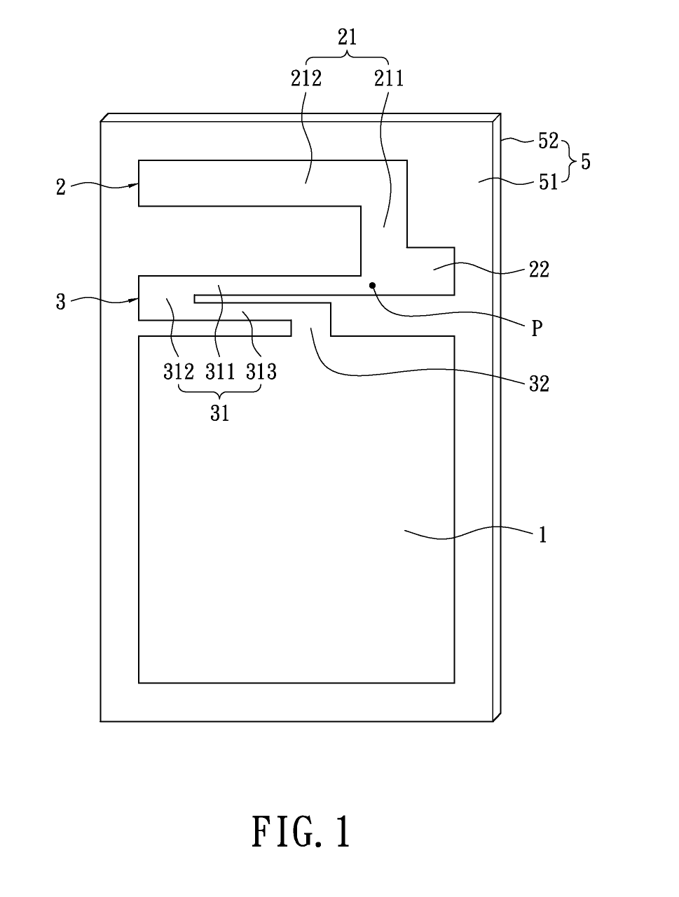

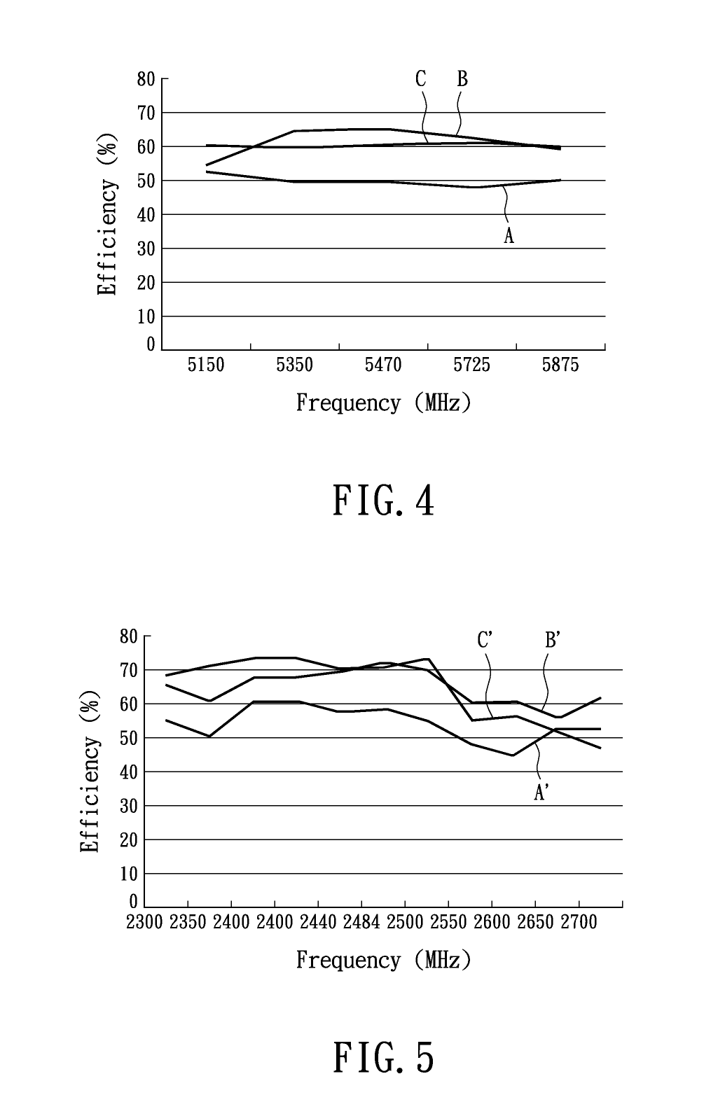

For a first embodiment of the instant disclosure, please refer to FIG. 1 in conjunction with FIGS. 4 and 5. FIG. 1 is a schematic view of the instant embodiment, while FIGS. 4 and 5 show the measured data of the instant embodiment.

As shown in FIG. 1, a multi-band antenna structure is formed on a substrate 5 for accepting a feed signal. The antenna structure has a grounding portion 1, a radiating portion 2 spaced apart from the grounding portion 1 and arranged on one side thereof, and a tuning portion 3 arranged between and bridging the grounding and the radiating portions.

The substrate 5 has a first surface 51 and a second surface 52. The first and second surfaces 51 and 52 are opposite surfaces of the substrate 5. For the instant embodiment, the antenna structure is formed on the first surface 51 of the substrate 5. Alternatively, the antenna structure may also be formed on the second surface 52 instead. Also, for the instant embodiment, the substrate 5 has a plate-like shape. However, in practice, the shape of the substrate 5 is not restricted. For example, the substrate 5 may have an arc-like shape.

For practical applications, the multi-band antenna structure may be adapted in tablet computers, laptops, mobile phones, or other wireless communication devices. Moreover, for the instant embodiment, the structural features of the antenna structure are illustrated by the referenced figures. However, in practice, based on the user's requirements, the structural configurations can be adjusted to meet the needs. For example, any segment of the antenna structure can be widened or display a wave-like shape.

The radiating portion 2 is bridged by the tuning portion 3 to the grounding portion 1. The radiating portion 2 has a first radiating segment 21 and a second radiating segment 22. The first radiating segment 21 has a portion thereof (for example, segment 211) bendingly arranged toward the grounding portion (1). The second radiating segment 22, being an extension structure of the first radiating segment 21, extends perpendicularly from the first radiating segment 21.

The tuning portion 3 is disposed between the first radiating segment 21 of the radiating portion 2 and the grounding portion 1. The tuning portion 3 has a hairpin segment 31 and a grounding segment 32. The hairpin segment 31 is substantially U-shaped. One end of the hairpin segment 31 is connected by one end of the first radiating segment 21 proximate to the grounding portion 1. The opposite ends of the grounding segment 32 are connected by the other end of the hairpin segment 31 and the grounding portion 1.

In greater detail, the hairpin segment 31 has a first arm 311, a connecting arm 312, and a second arm 313 formed in sequence. One end of the first arm 311 is connected by one end of the first radiating segment 21 proximate to the grounding portion 1. The opposite ends of the connecting arm 312 are connected by the other end of the first arm 311 and one end of the second arm 313. The second arm 313 is disposed between the first arm 311 and the grounding portion 1, where the other end of the second arm 313 is connected to the grounding segment 32.

For the instant embodiment, the first and second arms 311 and 313 are substantially parallel to one another. The connecting arm 312 is dimensionally shorter than the first arm 311. However, in practice, the structural configurations of the tuning portion 3 are not restricted.

Through the dimensional adjustment of the first and second arms 311 and 313 of the hairpin segment 31, the multi-band antenna structure is capable of increasing its frequency bandwidth, thus increasing the antenna efficiency.

The radiating portion 2 that functions cooperatively with the tuning portion 3 is described in more details hereinbelow. The first radiating segment 21 is substantially L-shaped. Namely, the first radiating segment 21 has a short arm 211 and a long arm 212 perpendicularly connected to each other. The first radiating segment 21 and the first arm 311 form a substantially U-shaped structure. The short arm 211 of the first radiating segment 21 is perpendicularly connected to the first arm 311. The long arm 212 of the first radiating segment 21 is parallel to the first arm 311.

In particular, the connecting location between the first radiating segment 21 and the hairpin segment 31 is defined as a feed point P for accepting the feed signal. More specifically, the location of the feed point P is defined on the short arm 211 of the first radiating segment 21 proximate to the hairpin segment 31.

Meanwhile, the relative locations between the short and long arms 211 and 212 of the first radiating segment 21 and their dimensions can be adjusted according to the user's needs, rather than being restricted by FIG. 1.

The second radiating segment 22 is connected to one end of the first radiating segment 21 proximate to the grounding portion 1. Namely, the second radiating segment 22 and the hairpin segment 31 share the same connecting location on the short arm 211 of the first radiating segment 21 pointing toward opposite directions. In other words, the second radiating segment 22 and the first arm 311 split from the first radiating segment 21 toward opposite directions.

In practice, the first radiating segment 21 can be used for low frequency operation, while the second radiating segment 22 is applicable for high frequency operation. The structural configurations of the multi-band antenna structure, such as the feed point P location, the length adjustment of the hairpin segment 31 for the tuning portion 3, and the relative position between the first and second radiating segments 21 and 22 of the radiating portion 2, enable the antenna structure to achieve higher efficiency for high and low frequency operations.

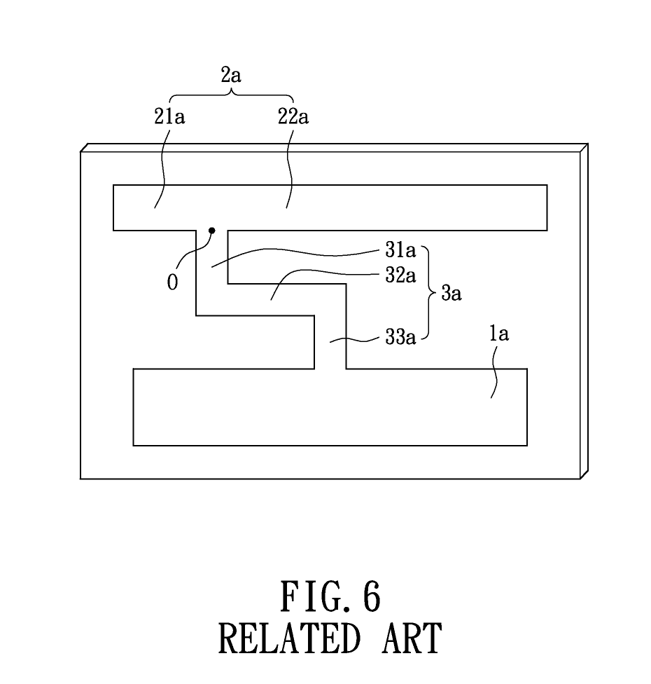

For the high frequency operation, the test results of the antenna structure of the instant disclosure are presented by the broken line B in FIG. 4. The measure data for the conventional antenna structure (as shown in FIG. 6) is presented by the broken line A. The comparison clearly shows significant improvement in efficiency for the antenna structure of the instant disclosure.

Similarly, for low frequency operation, the test results of the antenna structure of the instant disclosure are presented by the broken line B′ in FIG. 5. The measure data for the conventional antenna structure (as shown in FIG. 6) is presented by the broken line A′. The comparison clearly shows significant improvement in efficiency for the antenna structure of the instant disclosure.

The plots shown in FIGS. 4 and 5 verify the multi-band antenna structure of the instant embodiment can indeed provide better efficiency for both low and high frequency operations versus the conventional antenna.

### Second Embodiment

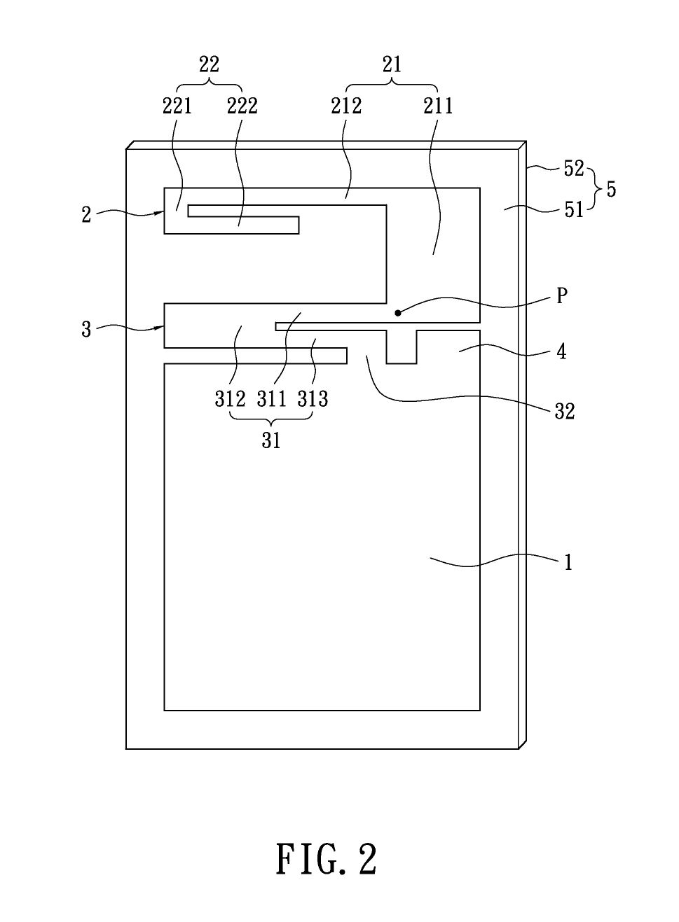

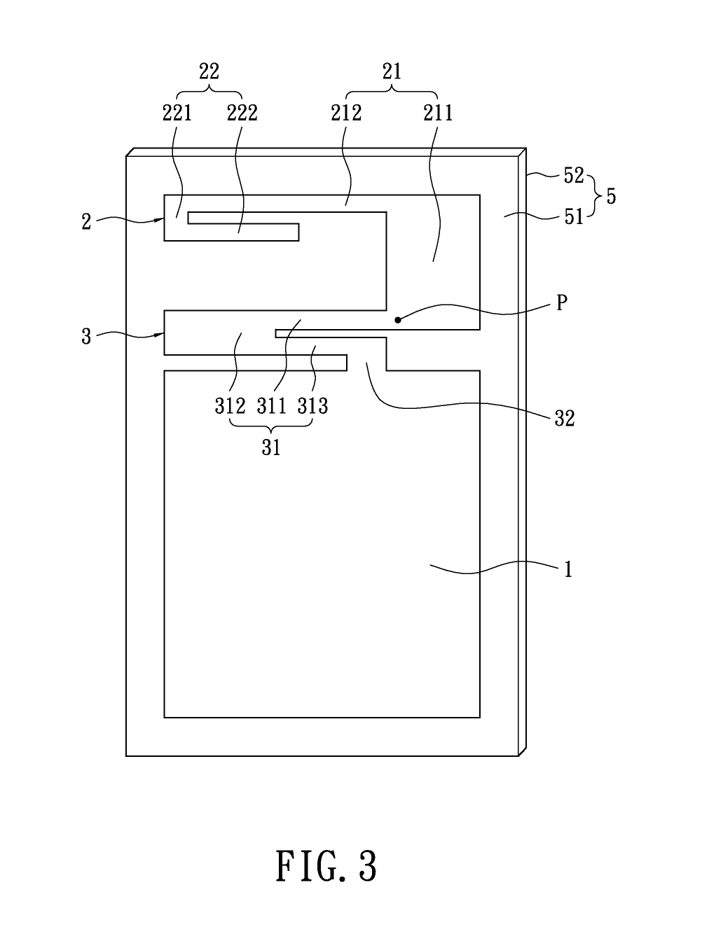

For a second embodiment of the instant disclosure, please refer to FIGS. 2˜5. FIGS. 2 and 3 are schematic views of the instant embodiment, while FIGS. 4 and 5 show the actual test results for the instant embodiment.

The instant embodiment is similar to the previous embodiment. Therefore, identical features are not described again hereinafter. Only the differences are explained hereinbelow.

As shown in FIG. 2, the first and second radiating segments 21 and 22 are both substantially L-shaped. In other words, the second radiating segment 22 also has a short arm 221 and a long arm 222 perpendicularly connected to each other.

The second radiating segment 22 is connected to one end of the first radiating segment 21 away from the grounding portion 1, and the second radiating segment 22 is disposed between the first radiating segment 21 and the first arm 311.

More specifically, the second radiating segment 22 extends from one end of the long arm 212 of the first radiating segment 21 toward the first arm 311. Then, the second radiating segment 22 is bent and extends toward the first radiating segment 21 parallel to the first arm 311. In other words, the short arm 221 of the second radiating segment 22 extends perpendicularly from the end of the long arm 212 of the first radiating segment 21 away from its short arm 211 toward the first arm 311. Then, the short arm 221 of the second radiating segment 22 is bent and extended toward the short arm 211 of the first radiating segment 21 parallel to the first arm 311 in forming the long arm 222 of the second radiating segment 22.

Meanwhile, the distance between the long arm 222 of the second radiating segment 22 and the long arm 212 of the first radiating segment 21 is less than the distance between the long arm 222 of the second radiating segment 22 and the first arm 311 of the hairpin segment 31. However, in practice, the structural configurations of the radiating portion 2 are not restricted by FIG. 2. For example, the relative positions between the short and long arms 211 and 212 of the first radiating segment 21 and their respective lengths can be adjusted based on the requirements of the user, and same principle is applied to the second radiating segment 22.

In practice, the first radiating segment 21 is used for high frequency operation, while the first and second radiating segments 21 and 22 work cooperatively to perform low frequency operation. Based on the structural configurations of the multi-band antenna structure of the instant embodiment, such as the location of the feed point P, the dimensional adjustment of the hairpin segment 31 of the tuning portion 3, and the relative positions between the first and second radiating segments 21 and 22 of the radiating portion 2, the antenna efficiency can be increased for high and low frequency operations. Moreover, the relative positions between the second radiating segment 22 and the hairpin segment 31 shown by the instant embodiment are favorable in generating a resonant frequency of 5 GHz. The structural characteristics of the instant embodiment also enable the antenna to occupy less space.

The antenna structure of the instant embodiment further has a coupling portion 4 for coupling to the high frequency segment (i.e., first radiating segment 21). The purpose is to increase the efficiency for high frequency operation. The coupling portion 4 extends from the grounding portion 1 in a direction toward the first radiating segment 21. More specifically, the coupling portion 4 extends from the grounding portion 1 across from the short arm 211 of the first radiating segment 21 in a direction toward the short arm 211 of the first radiating segment 21. The extended length of the coupling portion 4 is less than or equal to the distance between the short arm 211 of the first radiating segment 21 and the grounding portion 1, but is not restricted thereto.

However, in practice, the coupling portion 4 may also be omitted in constructing the antenna structure, as shown in FIG. 3.

The actual test results of the antenna structure for the instant embodiment at high frequency operation are shown in FIG. 4 by the broken line C. The measured data for the conventional antenna structure (as shown in FIG. 6) is represented by the broken line A. The comparison clearly shows a significant improvement in efficiency achieved by the antenna structure of the instant embodiment.

Similarly, for low frequency operation, the test results of the antenna structure of the instant disclosure are presented by the broken line C′ in FIG. 5. The measure data for the conventional antenna structure (as shown in FIG. 6) is presented by the broken line A′. The comparison clearly shows significant improvement in efficiency for the antenna structure of the instant disclosure.

The plots shown in FIGS. 4 and 5 verify the multi-band antenna structure of the instant embodiment can indeed provide better efficiency for both low and high frequency operations versus the conventional antenna.

### [Capabilities of the Embodiments]

Based on the above embodiments, the multi-band antenna structure of the instant disclosure can increase the efficiency for high and low frequency operations through the following: adjusting the location of the feed point P; adjusting the length of the hairpin segment 31 of the tuning portion 3; and adjusting the relative positions between the first and second radiating segments 21 and 22 of the radiating portion 2. Furthermore, the inclusion of the coupling portion 4 for coupling with the high frequency segment can also increase the antenna efficiency.

In addition, the increase in efficiency is verified by the test results in comparing to the conventional antenna, where significant improvement is achieved by the instant disclosure.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A multi-band antenna structure, comprising:
a grounding portion;
a radiating portion spaced apart from the grounding portion and arranged on one side thereof having a first radiating segment and a second radiating segment extending perpendicularly therefrom, wherein a portion of the first radiating portion points toward the grounding portion;
a tuning portion arranged between and connecting the grounding portion and the radiation portion having a substantially U-shaped hairpin segment and a grounding segment, wherein one end of the hairpin segment is connected to the portion of the first radiating segment that points toward the grounding portion while the other end thereof bendingly extends to form the grounding segment, the ground segment connecting the grounding portion;
wherein the interconnecting portion between the first radiating segment and the hairpin segment defines a feed point.

2. The multi-band antenna structure of claim 1, wherein the hairpin segment has first arm, a connecting arm, and a second arm sequentially connected, wherein the first arm is connected to the end of the first radiating segment proximate to the grounding portion, wherein opposite ends of the connecting arm are connected by the first arm and the second arm, and wherein the second arm is disposed between the first arm and the grounding portion and connected to the grounding portion.

3. The multi-band antenna structure of claim 2, wherein the first arm and the second arm are substantially parallel to each other.

4. The multi-band antenna structure of claim 2, wherein the first radiating segment and the first arm form a substantially U-shaped structure.

5. The multi-band antenna structure of claim 4, wherein the second radiating segment is connected to the end of the first radiating segment proximate the grounding portion, and wherein the second radiating segment and the first arm extend from the same connecting region on the first radiating segment in opposite directions.

6. The multi-band antenna structure of claim 5, wherein the second arm is dimensionally shorter than the first arm.

7. The multi-band antenna structure of claim 4, wherein the second radiating segment is connected to one end of the first radiating segment away from the grounding portion, and wherein the second radiating segment is disposed between the first radiating segment and the first arm.

8. The multi-band antenna structure of claim 7, wherein the first radiating segment and the second radiating segment each is substantially L-shaped.

9. The multi-band antenna structure of claim 8, wherein the second radiating segment extends from the end of the first radiating segment away from the grounding portion in a direction toward the first arm and bends to extend toward the first radiating segment parallel to the first arm.

10. The multi-band antenna structure of claim 9, further comprising a coupling portion for coupling to the radiating portion, wherein the coupling portion extends from the ground portion in a direction toward the first radiating segment.
